(19) United States
(12) Patent Application Publication
(10) Pub. No.: US 2023/0355464 A1
(43) Pub. Date: Nov. 9, 2023

(54) System and Method For Locking Percussion Settings on a Massage Device

(71) Applicant: PlayMakar Inc., Fort Worth, TX (US)

(72) Inventors: Michael James Williams, Colleyville, TX (US); Federico G. Vierheller, Fort Worth, TX (US); Wesley A. Coleman, N. Richland Hills, TX (US)

(73) Assignee: PlayMakar Inc., Fort Worth, TX (US)

(21) Appl. No.: 17/740,143

(22) Filed: May 9, 2022

(51) Int. Cl. A61H 23/00; A61H 23/02

(52) U.S. Cl. CPC A61H 23/006; A61H 23/0254; A61H 2201/1418; A61H 2201/149; A61H 2201/5025

(57) ABSTRACT

A percussion massager feature describe herein provides for locking the control display through the touchscreen of the percussion massager to ensure accidental bumps to the display do not disrupt treatment.

### CROSS-REFERENCE TO RELATED APPLICATIONS

The following applications and patent are incorporated herein by reference in their entireties: U.S. patent application Ser. No. 17/223,840 entitled PERCUSSIVE MASSAGER ROTATIONAL ACCESSORY, filed Apr. 6, 2021; U.S. patent application Ser. No. 17/229,860 entitled VARIABLE STROKE PERCUSSIVE MASSAGE DEVICE, filed Apr. 13, 2021, now U.S. Pat. No. 11,253,423; U.S. patent application Ser. No. 17/508,954 entitled CONSTRAINED AND REPOSITIONABLE PERCUSSIVE MASSAGE DEVICE TOOL AND TOOL RECEIVER, filed Oct. 22, 2021; U.S. patent application Ser. No. 17/524,732 entitled PERCUSSION MASSAGER HAVING VARIABLE AND SELECTABLE STROKE LENGTH filed Nov. 11, 2021; and U.S. patent application Ser. No. 17/714,140 entitled SELECTABLE, CONFIGURABLE AND INTERCHANGEABLE MASSAGE TOOL HEAD SYSTEM FOR PERCUSSION MASSAGE DEVICES filed Apr. 5, 2022, each of which is commonly owned and list overlapping inventors.

### BACKGROUND

### Technical Field

The embodiments herein are generally directed to a setting locking feature for a percussion massage device and more particularly to a feature accessible via a touch display of a percussion massage device which facilitates locking (and unlocking) of an established mode of operation.

### Description of Related Art

Massage devices are known in the art and present uses include, but are not limited to, pre-work out warm-up or post-activity recovery to increase range of motion and flexibility when administered before sports activity and muscle pliability where massage techniques are applied with a thumb, palm and elbow, used to reduce stress, increase relaxation, reduce pain and muscle soreness and tension. Improving circulation, energy and alertness. Massage devices have also been known to help prevent sore muscles after exercise known as “delayed onset muscle soreness or DOMS. Such massage devices are used in, for example, athletic, physiotherapeutic and chiropractic environments and to a much larger extent now in the home environment.

Massage devices, such as those sold by Applicant, PlayMakar, Inc. are handheld vibratory or percussive massage devices which allow users to quickly adjust settings, e.g., level of percussion and stroke length, with one hand, while still holding the device with the same hand. In newer devices, control features may be incorporated into a touchscreen display, which is susceptible to inadvertent bumps and can suddenly change settings. Such a change, while annoying at the very least, can also cause additional discomfort when the user is already experiencing sensitivity or sore muscles. Further, inadvertent changes in strokes per minute (SPM) could potentially disrupt treatment, cause pain and/or cause poor user experience.

Accordingly, there is a need in the art for a system and method that ensures accidental bumps do not alter settings on a massage device.

### SUMMARY OF THE EMBODIMENTS

In a first non-limiting embodiment, a process for selecting and locking user settings of a percussion massage device includes: powering on the percussion massage device; selecting via a touchscreen display of the percussion massage device a percussion mode from a range of percussion modes, and locking the touchscreen display to lock in the selected percussion mode, wherein locking includes pressing at least a first icon on the touchscreen display for a predetermined amount of time.

In a second non-limiting embodiment, a handheld percussion massage device comprising: a power switch; and a touchscreen for facilitating user selection of massage settings, the touchscreen including a first icon and a second icon for facilitating (i) user selection of a strokes-per-minute value and (ii) locking and unlocking the touchscreen to lock-in or unlock the massage settings.

### BRIEF DESCRIPTION OF DRAWINGS

Example embodiments will become more fully understood from the detailed description given herein below and the accompanying drawings, wherein like elements are represented by like reference characters, which are given by way of illustration only and thus are not limitative of the example embodiments herein.

FIGS. 1a, 1b and 1c illustrate a percussion massage device having a touchscreen in accordance with the preferred embodiment described herein; and

FIG. 2 illustrates an exemplary controller board for the touchscreen of the percussion massage device in accordance with the preferred embodiment described herein.

### DETAILED DESCRIPTION

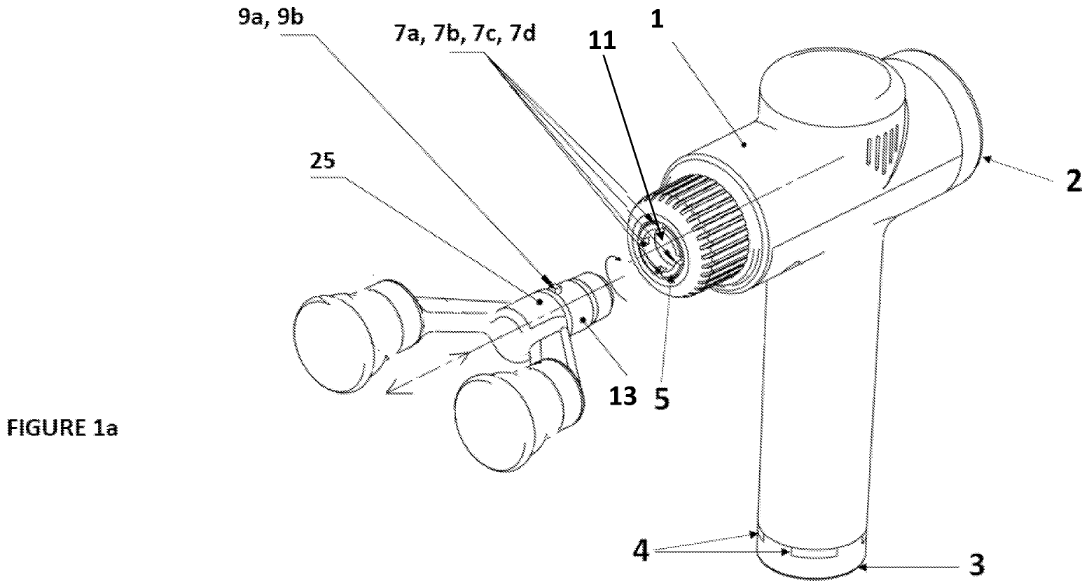

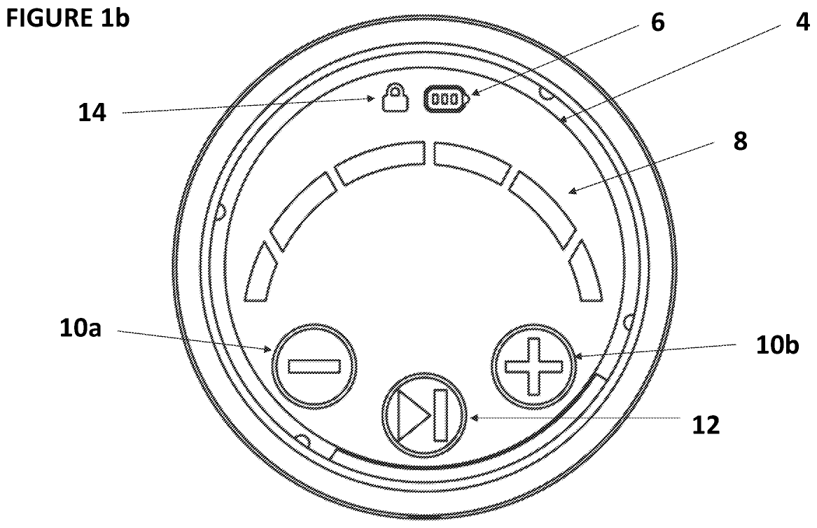

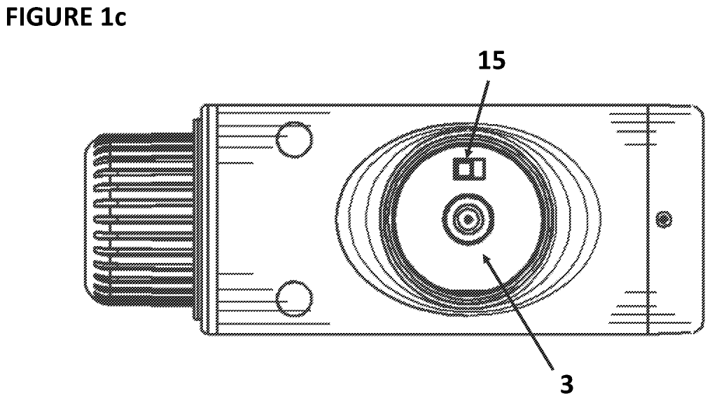

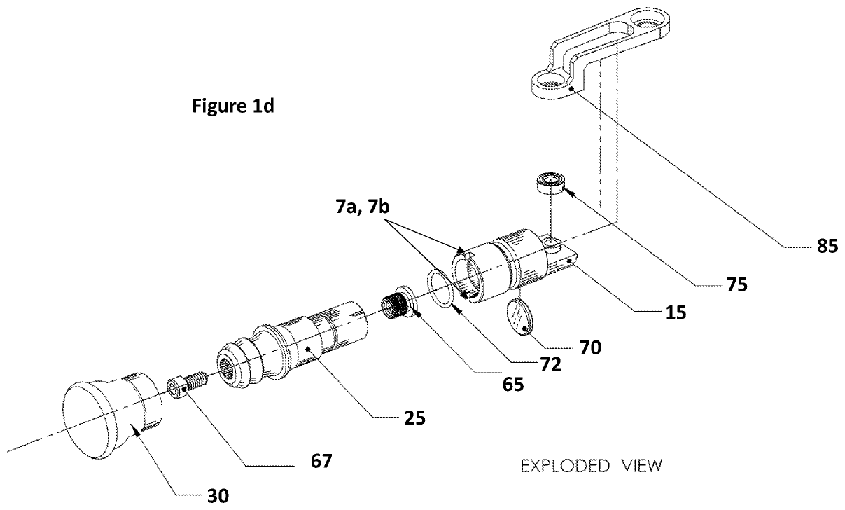

FIGS. 1a, 1b and 1c illustrate an exemplary percussion massage device 1 which may incorporate the screen locking feature described further herein. The device 1 includes: touchscreen display 2, base 3 which incorporates transparent windows 4 around and within a circumference thereof and a tool holder 5. The percussion massage device 1 of FIG. 1a receives a massage tool (not shown, but described in at least U.S. Pat. No. 11,253,423 and Ser. No. 17/714,140), which may be one of various configurations, in the tool holder 5 thereof. The percussion massage device 1 of FIG. 1a facilitates attachment/de-attachment of tool heads to/from tool holder 5 in accordance with a key and keyway (see key ways 7a, 7b, 7c, 7d in FIG. 1a) attachment system. The embodiments are not so limited. For example, a magnetic attachment system described in U.S. application Ser. No. 17/508,954 may also be used.

Referring to FIG. 1b, touchscreen display 2 (of device 1 in FIG. 1a), provides status indicators (or icons), e.g., battery charge level 6, percussion level 8, as well as mechanisms 10a (−), 10b (+) for facilitating user adjustment down(−)/up(+) of SPM and a selection mechanism for facilitating user selection of a preferred stroke length from two available stroke lengths (short or long) by reversing direction of the motor rotation 12 (pause/play button). Additionally, a lock indicator icon 14 is included to indicate when the present setting have been locked in in accordance with the steps described herein. Each of the touchscreen features includes light up functionality enabled by LED components which may include single or multiple colors in accordance with desired indicators. Both the battery charge level 6 and percussion level 8 indicators include multiple windows which are illuminated or not illuminated in accordance with the level of charge and the level of percussion, i.e., strokes-per-minute, respectively.

In a preferred embodiment, a user first turns on the percussion massager using a slide switch 15 which may be located on the bottom of base 3 of the device 1 as shown in bottom view FIG. 1c. Alternatively, the power may be turned on/off by pressing an icon on the touchscreen. The touchscreen display and power indicator lights will turn on. The user selects desired settings using the touchscreen display e.g., SPM Level using mechanisms (e.g., keys) 10a (−), 10b (+) and/or stroke length (short or long) or to reverse direction of the motor rotation using 12. In order to lock in these settings, the user may lock the touch screen by hold down both 10a (−) and 10b (+) keys simultaneously for a predetermined amount of time, e.g., 3 seconds. This will cause the lock indicator icon 14 to appear lit on the display, confirming that the screen is locked. To unlock the touchscreen, hold down both 10a (−) and 10b (+) keys for the same predetermined amount of time, e.g., 3 seconds. If the screen is in locked mode when the user powers off the device, the lock function is disabled upon powering down.

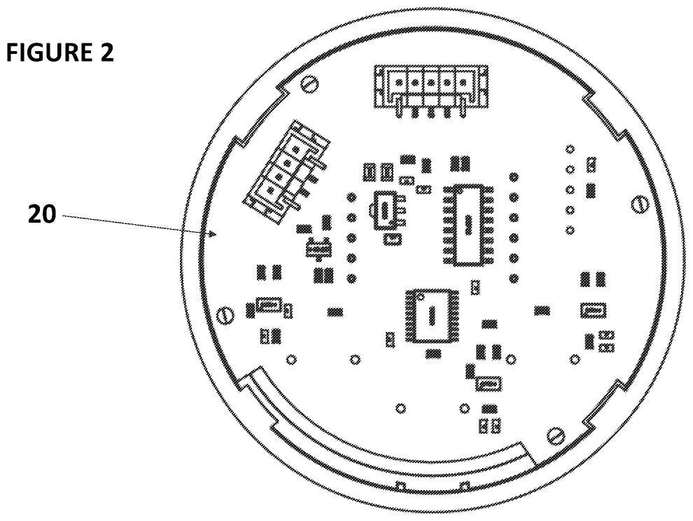

As shown in FIG. 2, to implement the touchscreen display 4 with various selection and locking features described herein, touchscreen 4 includes a controller board 20 which includes various microelectronic components thereon. One skilled in the art will recognize the numerous configurations and technologies which may be used including, but not limited to: printed circuit boards, surface-mount technology, microcontrollers, capacitors, digital signal processors (DSPs), electrodes, light emitting diodes (LEDs). The touchscreen may be resistive or capacitive.

The embodiment set forth above is exemplary. Unless otherwise defined, all technical and scientific terms used herein have the same meaning as commonly understood by one of ordinary skill in the art to which the embodiment belongs. The massage device with screen locking feature may be embodied in other specific forms without departing from the spirit or essential attributes thereof, and it is therefore desired that the present embodiment be considered in all respects as illustrative and not restrictive.

1.-8. (canceled)

9. A handheld percussion massage device including a user selection locking mechanism to avoid accidental bumping and inadvertently causing the user discomfort during use of the device, the device comprising:
a tool receiver for receiving a massage tool therein, the tool receiver including a piston for providing percussive action to the massage tool;
the massage tool, including a hollow attachment post at a first end thereof for insertion into the tool receiver and selectively attaching to the tool receiver and engaging with the piston, wherein the tool receiver includes one or more keyways and the hollow attachment post includes one or more keys for engaging with at least one of the one or more keyways to secure the massage tool to the tool receiver and engage with the piston to facilitate the piston providing percussive action along a longitudinal axis of the hollow attachment post, and further wherein the massage tool, including hollow attachment post, is removable from the tool receiver;
the massage tool further including at least one interchangeable tool head tip attached to at least one second end of the hollow attachment post, the at least one interchangeable tool head tip being removable from the massage tool, wherein the massage tool includes an adjustment means for adjusting a hardness of each at least one interchangeable tool head tip;
a power switch; and
a touchscreen for facilitating user selection of massage settings, the touchscreen including a first icon and a second icon for facilitating (i) user selection of a strokes-per-minute value of the piston and (ii) locking and unlocking the touchscreen to lock-in or unlock the massage settings.

10. The handheld percussion massage device of claim 9, wherein pressing the first icon reduces the strokes-per-minute value and pressing the second icon increases the strokes-per-minute value.

11. The handheld percussion massage device of claim 9, further comprising a third icon for facilitating user selection of a stroke length.

12. The handheld percussion massage device of claim 9, wherein pressing the first icon and second icon simultaneously for a predetermined amount of time will lock or unlock the touchscreen.

13. The handheld percussion massage device of claim 12, wherein the predetermined amount of time is 3 seconds.

14. The handheld percussion massage device of claim 11, wherein each stroke length selection is indicated by a different illuminated color of the third icon.

15. A handheld percussion massage device including a user selection locking mechanism to avoid accidental bumping and inadvertently causing the user discomfort during use of the device, the device comprising:
a power switch; and
a touchscreen for facilitating user selection of massage settings, the touchscreen including a first icon and a second icon for facilitating (i) user selection of a strokes-per-minute value of a piston and (ii) locking and unlocking the touchscreen to lock-in or unlock the massage settings;
a tool holder for receiving a massage tool therein, the tool holder including the piston for providing percussive action to the massage tool; and
the massage tool, including an attachment post at a first end thereof for insertion into the tool holder and selectively attaching to the tool holder and engaging with the piston, wherein the tool holder includes multiple keyways and the attachment post includes multiple keys for engaging with at least some of the keyways to secure the massage tool to the tool holder, and further wherein the massage tool, including attachment post, is removable from the tool holder;
the massage tool further including at least one removable and interchangeable tool head tip attached thereto, wherein the massage tool includes an adjustment means for adjusting a hardness of each at least one interchangeable tool head tip.

16. The handheld percussion massage device of claim 15, wherein pressing the first icon reduces the strokes-per-minute value and pressing the second icon increases the strokes-per-minute value.

17. The handheld percussion massage device of claim 15, further comprising a third icon for facilitating user selection of a stroke length.

18. The handheld percussion massage device of claim 15, wherein pressing the first icon and second icon simultaneously for a predetermined amount of time will lock or unlock the touchscreen.

19. The handheld percussion massage device of claim 18, wherein the predetermined amount of time is 3 seconds.

20. The handheld percussion massage device of claim 17, wherein each stroke length selection is indicated by a different illuminated color of the third icon.

21. (canceled)

22. (canceled)

23. (canceled)

24. The handheld percussion massage device of claim 15, wherein the massage tool includes a hollow attachment shaft attached to the tool holder at a first end and attached to at least one removable and interchangeable tool head tip at a second end.
